(19) United States
(12) Patent Application Publication
(10) Pub. No.: US 2025/0180946 A1
(43) Pub. Date: Jun. 5, 2025

(54) ELECTRONIC MIRROR AND METHOD FOR CONTROLLING SAME

(71) Applicant: PANASONIC AUTOMOTIVE SYSTEMS CO., LTD., Kanagawa (JP)

(72) Inventors: Hiroaki SATO, Kanagawa (JP); Naohiro MITANI, Kanagawa (JP); Tetsuya KOHGA, Tokyo (JP)

(73) Assignee: PANASONIC AUTOMOTIVE SYSTEMS CO., LTD., Kanagawa (JP)

(21) Appl. No.: 19/043,139

(22) Filed: Jan. 31, 2025

Related U.S. Application Data
(63) Continuation of application No. PCT/JP2024/004809, filed on Feb. 13, 2024.

(30) Foreign Application Priority Data
Mar. 24, 2023 (JP) 2023-048162

(51) Int. Cl. G02F 1/1335

(52) U.S. Cl. CPC G02F 1/133528; G02F 2203/02

(57) ABSTRACT

An electronic mirror includes: a first polarization plate; a liquid crystal layer disposed on a back surface side of the first polarization plate and configured to control optical rotation of light by an applied voltage; a reflection-type polarization plate disposed on a back surface side of the liquid crystal layer and configured to reflect or transmit light from the liquid crystal layer based on a polarization axis; a second polarization plate disposed on a back surface side of the reflection-type polarization plate; a liquid crystal cell disposed on a back surface side of the second polarization plate; and a backlight disposed on a back surface side of the liquid crystal cell, and haze of the second polarization plate is within a range of 3.0% to 8.0%.

### CROSS-REFERENCE TO RELATED APPLICATIONS

This is a continuation of International Application No. PCT/JP2024/004809 filed on Feb. 13, 2024, and claims priority from Japanese Patent Application No. 2023-048162 filed on Mar. 24, 2023, the entire content of which is incorporated herein by reference.

### TECHNICAL FIELD

The present disclosure relates to an electronic mirror and a method for controlling the same.

### BACKGROUND ART

During the driving of a vehicle or the like, illumination light from the surrounding vehicle or the like is reflected by an in-vehicle mirror, which may cause an event of deteriorating the operability of the vehicle of a driver. In the related art, in response to this, some in-vehicle electronic mirrors have an anti-glare function.

For example, Patent Literature 1 discloses a configuration in which a liquid crystal anti-glare mirror switchable between anti-glare and non-anti-glare can provide a bright screen with a small transmission loss.

### CITATION LIST

### Patent Literature

Patent Literature 1: JP2009-008881A

### SUMMARY OF INVENTION

### Technical Problem

An electronic mirror that provides the anti-glare function may, under certain circumstances, result in reduced visibility for a user.

In view of the above problems, an object of the present disclosure is to provide a configuration for suppressing a reduction in visibility of a user in an electronic mirror that provides an anti-glare function.

### Solution to Problem

The present disclosure provides an electronic mirror including: a first polarization plate; a liquid crystal layer disposed on a back surface side of the first polarization plate and configured to control optical rotation of light by an applied voltage; a reflection-type polarization plate disposed on a back surface side of the liquid crystal layer and configured to reflect or transmit light from the liquid crystal layer based on a polarization axis; a second polarization plate disposed on a back surface side of the reflection-type polarization plate; a liquid crystal cell disposed on a back surface side of the second polarization plate; and a backlight disposed on a back surface side of the liquid crystal cell, in which haze of the second polarization plate is configured to be within a range of 3.0% to 8.0%.

Further, the present disclosure provides an electronic mirror including: a first polarization plate; a liquid crystal layer disposed on a back surface side of the first polarization plate and configured to control optical rotation of light by an applied voltage; a reflection-type polarization plate disposed on a back surface side of the liquid crystal layer and configured to reflect or transmit light from the liquid crystal layer based on a polarization axis; a second polarization plate disposed on a back surface side of the reflection-type polarization plate; a liquid crystal cell disposed on a back surface side of the second polarization plate; and a backlight disposed on a back surface side of the liquid crystal cell, in which the reflection-type polarization plate and the second polarization plate are adhered by an adhesive member.

Further, the present disclosure provides an electronic mirror including: a first polarization plate; a liquid crystal layer disposed on a back surface side of the first polarization plate and configured to control optical rotation of light by an applied voltage; a reflection-type polarization plate disposed on a back surface side of the liquid crystal layer and configured to reflect or transmit light from the liquid crystal layer based on a polarization axis; a liquid crystal cell disposed on a back surface side of the reflection-type polarization plate; and a backlight disposed on a back surface side of the liquid crystal cell.

Further, the present disclosure provides an electronic mirror that is capable of switching an anti-glare function, the electronic mirror including: a display structure in which the reflectance of light is controlled; an illuminance sensor configured to acquire a first illuminance from a front surface side of the display structure and a second illuminance from a back surface side of the display structure; and a control circuit configured to control the anti-glare function by adjusting an applied voltage to a liquid crystal layer provided in the display structure based on the first illuminance and the second illuminance, in which the control circuit adjusts the applied voltage such that the reflectance of the display structure falls within a predetermined range during operation of the anti-glare function.

Further, the present disclosure provides a method for controlling an electronic mirror that is capable of switching an anti-glare function includes: an acquisition step of acquiring a first illuminance from a front surface side of a display structure of the electronic mirror and a second illuminance from a back surface side of the display structure; and a control step of controlling the anti-glare function by adjusting an applied voltage to a liquid crystal layer provided in the display structure of the electronic mirror and controlling the reflectance of light of the display structure based on the first illuminance and the second illuminance, in which the applied voltage is adjusted such that the reflectance of the display structure falls within a predetermined range during operation of the anti-glare function.

Any combination of the above components, and conversion of an expression of the present disclosure between a method, a device, a system, a storage medium, a computer program, and the like are also effective in an aspect of the present disclosure.

### Advantageous Effects of Invention

According to the present disclosure, it is possible to provide a configuration for suppressing a reduction in the visibility of a user in the electronic mirror that provides the anti-glare function.

### BRIEF DESCRIPTION OF DRAWINGS

FIG. 1 is a block diagram showing a functional configuration example of an electronic mirror according to Embodiment 1 of the present disclosure;

FIGS. 2A to 2C show schematic views for illustrating a white blur on the electronic mirror;

FIG. 3 is a schematic view for illustrating a layer structure of the electronic mirror according to Embodiment 1 of the present disclosure;

FIGS. 4A and 4B show conceptual diagrams for illustrating double reflection, a rainbow, and the white blur on the electronic mirror;

FIG. 5 is a table showing an evaluation example according to Embodiment 1 of the present disclosure;

FIG. 6 is a schematic view for illustrating a layer structure of an electronic mirror according to Embodiment 2 of the present disclosure;

FIG. 7 is a schematic view for illustrating a layer structure of an electronic mirror according to Embodiment 3 of the present disclosure;

FIG. 8 is a schematic view for illustrating a layer structure of an electronic mirror according to Embodiment 4 of the present disclosure;

FIG. 9 is a graph for illustrating a relationship between an applied voltage to a liquid crystal layer according to Embodiment 4 of the present disclosure and reflected light;

FIG. 10 is a flowchart of a method for controlling an electronic mirror according to Embodiment 5 of the present disclosure; and

FIGS. 11A and 11B show graphs illustrating control according to Embodiment 5 of the present disclosure.

### DESCRIPTION OF EMBODIMENTS

Hereinafter, embodiments that specifically disclose an electronic mirror and a method for controlling the electronic mirror according to the present disclosure will be described in detail with reference to the accompanying drawings as appropriate. However, unnecessarily detailed descriptions may be omitted. For example, the detailed descriptions of well-known matters or the redundant descriptions of substantially the same configuration may be omitted. This is to avoid unnecessary redundancy of the following description and facilitate understanding of those skilled in the art. The accompanying drawings and the following description are provided for those skilled in the art to fully understand the present disclosure, and are not intended to limit the subject matters described in the claims.

### Findings of Inventor

For example, an electronic mirror is switchable between a mode in which the electronic mirror functions as a normal mirror (hereinafter, also referred to as a “mirror mode”) and a mode in which any image is displayed on a liquid crystal display (hereinafter, also referred to as a “display mode”). Further, it is known to realize an anti-glare function as described above in the mirror mode. When the electronic mirror is operated in the mirror mode, operation of the liquid crystal display provided in the electronic mirror is usually stopped. Therefore, reflected light from a surface of the liquid crystal display tends to increase due to the structure. As the reflected light increases, the reflected light from the liquid crystal electronic mirror is scattered due to the reflection characteristics of members on an optical path in the electronic mirror, and light with a blurred contour (hereinafter, also referred to as a “white blur”) may appear. In addition, unintended reflected light is generated due to a layer structure of the liquid crystal electronic mirror, and double reflection, a rainbow, or the like may occur on a surface of a display structure. This phenomenon decreases the visibility of a driver, and as a result, may lead to a reduction in the operability of a vehicle.

### Embodiment 1

A configuration example of a liquid crystal electronic mirror (hereinafter, also simply referred to as an “electronic mirror”) according to the present embodiment will be described. The electronic mirror may be, for example, an in-vehicle inner mirror or an outer mirror. Further, the type of a moving body on which the electronic mirror is mounted is not particularly limited, and may be a four-wheeled vehicle such as an ordinary passenger vehicle or a two-wheeled vehicle such as a motorcycle.

### Functional Configuration

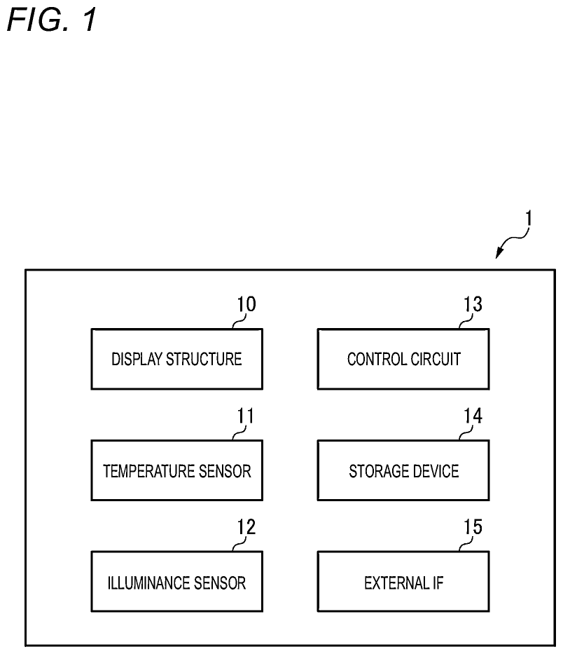

FIG. 1 is a diagram showing an example of a device configuration of an electronic mirror 1 according to the present embodiment. The electronic mirror 1 includes a display structure 10, a temperature sensor 11, an illuminance sensor 12, a control circuit 13, a storage device 14, and an external IF 15. The configuration of the electronic mirror 1 is an example, some of the portions shown in FIG. 1 may be provided on a vehicle (not shown) side, and when mounted on the vehicle, they may cooperate with portions on the vehicle side to implement functions to be described later.

The display structure 10 has a layer structure to be described later, and functions by switching between the mirror mode and the display mode. The temperature sensor 11 detects a peripheral temperature of the electronic mirror 1 as temperature information. The illuminance sensor 12 detects illuminance of light received by the electronic mirror 1 as illuminance information.

The control circuit 13 controls the operation of the electronic mirror 1, particularly the display structure 10, by reading and executing various programs and data stored in the storage device 14. The storage device 14 is implemented by, for example, a volatile and nonvolatile storage device such as a random access memory (hereinafter, referred to as “RAM”) or a read only memory (hereinafter, referred to as “ROM”), and stores various programs and data necessary for executing the operation of the electronic mirror 1. The RAM is, for example, a work memory used during operation of the electronic mirror 1. The ROM stores and holds in advance, for example, a program and data for controlling the electronic mirror 1.

The external IF 15 is an interface for transmitting and receiving data to and from an external device (not shown), and is communicably connected to a control device of the vehicle on which the electronic mirror 1 is mounted, for example, via a controller area network (hereinafter, referred to as a “CAN”). The external IF 15 may operate as an interface for supplying power to the electronic mirror 1.

### White Blur

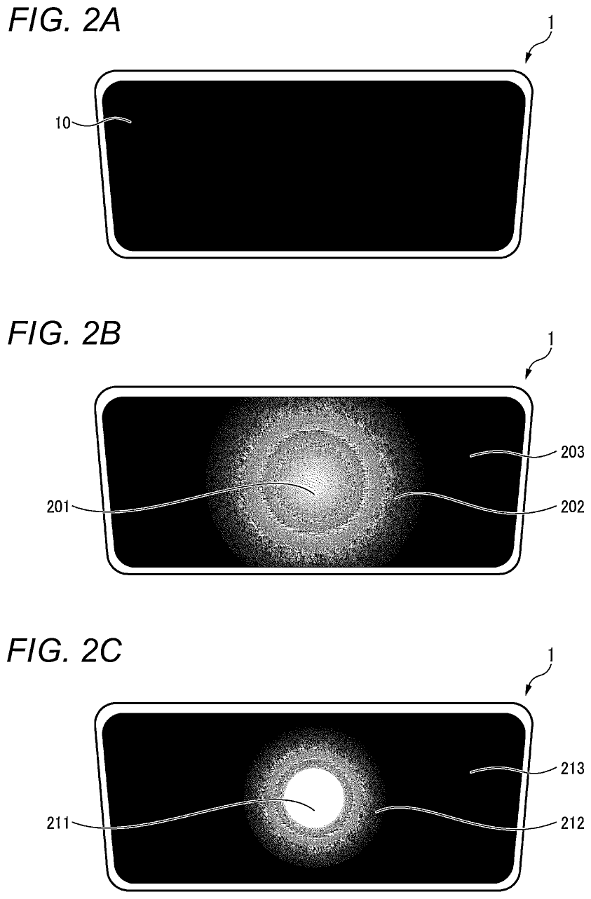

Hereinafter, the “white blur” according to the present embodiment will be described with reference to FIG. 2A to 2C. The white blur is, a phenomenon in which, for example, when light is irradiated onto the electronic mirror 1 from another vehicle, the outline of the light and its surroundings appear blurred on the display structure 10 due to the structure of the electronic mirror 1, or the like. The white blur may be a factor that reduces the visibility of the driver of the vehicle using the electronic mirror 1.

FIG. 2A is a diagram showing an external configuration example of the electronic mirror 1. Here, it is assumed that the electronic mirror 1 is in the mirror mode and operates as the normal mirror. In FIG. 2A, the display structure 10 is in a dark state. Although a center of the display structure 10 is irradiated with light in FIG. 2B, a center 201 of the light is blurred, and a peripheral region 202 is also blurred. A peripheral region 203 is a dark region. That is, the white blur occurs. In FIG. 2C, light is emitted similarly to FIG. 2B, but a center 211 of the light appears more clearly than in FIG. 2B. A peripheral region 212 of the center 211 is blurred. A peripheral region 213 is a dark region. That is, the state of FIG. 2C is an example of a state in which the degree of the white blur is suppressed compared to the state of FIG. 2B.

### Layer Structure of Display Structure

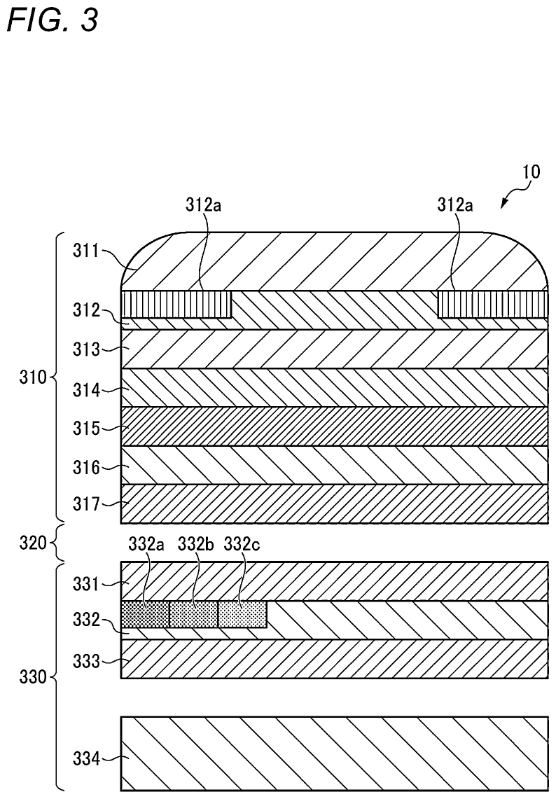

FIG. 3 is a schematic view for illustrating a layer structure of the display structure 10 according to the present embodiment. In FIG. 3, an upper side (a glass layer 311 side) corresponds to a front surface side of the electronic mirror 1, and a lower side (a backlight 334 side) corresponds to a back surface side of the electronic mirror 1. Here, the front surface side here is, for example, a side where the driver who uses the electronic mirror 1 is located.

The electronic mirror 1 according to the present embodiment includes a front surface structure 310 and a display 330, and an air gap 320 is located between the front surface structure 310 and the display 330.

In the front surface structure 310, a glass layer 311, an adhesive layer 312, a protective layer 313, an adhesive layer 314, a polarization plate 315, a liquid crystal layer 316, and a reflection-type polarization plate 317 are stacked in this order from the front surface side. In the present embodiment, a structure including the polarization plate 315, the liquid crystal layer 316, and the reflection-type polarization plate 317 may be referred to as a reflectance control mechanism. The adhesive layer 312 and the adhesive layer 314 are implemented by, for example, an optical clear adhesive (hereinafter, referred to as an “OCA”). The glass layer 311 and the adhesive layer 312 are adhered to each other, for example, at end portion regions 312a of the adhesive layer 312 by vapor deposition. The protective layer 313 is made of, for example, polyethylene terephthalate (hereinafter, referred to as “PET”).

The liquid crystal layer 316 is made of a known twisted nematic (TN) liquid crystal. The liquid crystal layer 316 is configured to switch a direction of liquid crystal molecules by switching an applied voltage. By switching the directions of the liquid crystal molecules, transmission and blocking of light is controlled according to polarization directions of the polarization plate 315 and the reflection-type polarization plate 317. In the case of the TN liquid crystal, the light is transmitted through the polarization plate located around the TN liquid crystal by developing optical rotation of the light in a state where no voltage is applied, and is blocked by the polarization plate in a state where the voltage is applied. The configuration and characteristics of the TN liquid crystal are known, and a detailed description thereof is omitted here.

The polarization plate 315 and the reflection-type polarization plate 317 located around the liquid crystal layer 316 are provided such that polarization axes thereof are orthogonal to each other, and transmit polarization components corresponding to the polarization axes. In the reflection-type polarization plate 317, light orthogonal to the polarization axis is reflected at high reflectance, and a component parallel to a parallel axis is reflected at low reflectance. That is, the component parallel to the parallel axis is transmitted through the reflection-type polarization plate 317. In other words, by adjusting the reflection of light by the reflection-type polarization plate 317 by the applied voltage to the liquid crystal layer 316 constituting the reflectance control mechanism, the reflectance is adjusted by the reflectance control mechanism.

In the display 330, an upper polarization plate 331, a liquid crystal cell 332, a lower polarization plate 333, and a backlight 334 are stacked in this order from the front surface side. The upper polarization plate 331 and the lower polarization plate 333 have polarization axes provided along a predetermined direction, and transmit light components through the polarization axes. The upper and lower directions of the upper polarization plate 331 and the lower polarization plate 333 merely indicate a relative positional relationship with respect to the liquid crystal cell 332, and are not intended to be interpreted in a limited manner. In the liquid crystal cell 332, a cell 332a, a cell 332b, and a cell 332c corresponding to red (R), green (G), and blue (B), respectively, are disposed according to a predetermined rule. The backlight 334 functions as a light source, and includes, for example, a light emitting diode (hereinafter, referred to as an “LED”).

### Reflection Principle

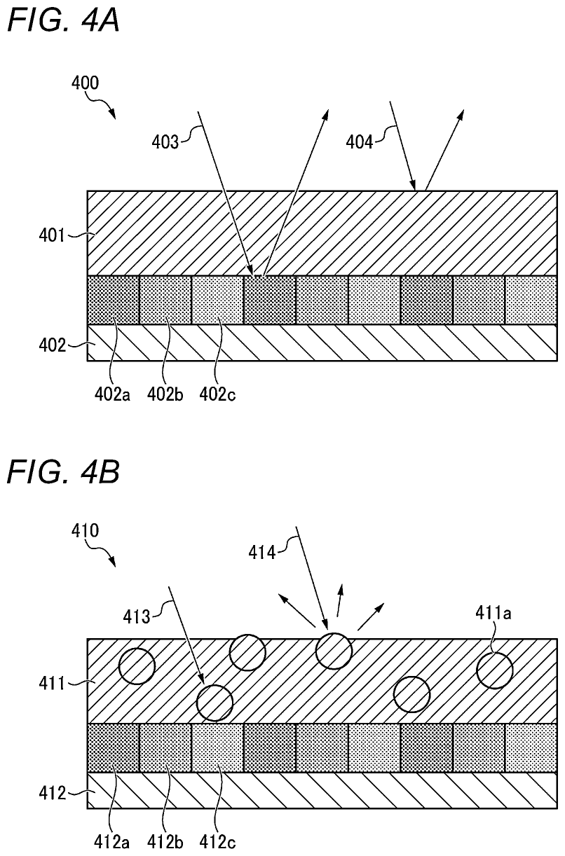

Here, the principle of occurrence of reflection caused by the layer structure of the display structure will be described with reference to FIG. 4A and 4B. FIG. 4A is an enlarged view of the vicinity of the liquid crystal cell in a display having the display structure as shown in FIG. 3. A display 400 includes an upper polarization plate 401 and a liquid crystal cell 402. In the liquid crystal cell 402, a cell 402a, a cell 402b, and a cell 402c corresponding to RGB are disposed according to a predetermined rule. At this time, it is assumed that the upper polarization plate 401 is subjected to surface treatment of hard coat (HC) or anti-reflection (AR) to reduce diffuse reflection.

As described with reference to FIG. 3, transmittance of light in the reflectance control mechanism is controlled in accordance with the applied voltage to the liquid crystal layer 316. At this time, when the reflectance control mechanism is controlled such that light is reflected by the reflection-type polarization plate 317, that is, the reflectance of the reflection-type polarization plate 317 is high, the degree to which light reaches the display 330 decreases. On the other hand, when the reflectance control mechanism is controlled such that the light is transmitted through the reflection-type polarization plate 317, that is, the reflectance of the reflection-type polarization plate 317 is low, the degree to which light reaches the display 330 increases.

In such a configuration, double reflection caused by the reflected light from the reflection-type polarization plate 317 of the front surface structure 310 and the reflected light 404 from an upper surface of the upper polarization plate 401 of the display 330 may appear on a surface of the display structure 10. The degree to which the double reflection occurs varies depending on the applied voltage to the liquid crystal layer 316, that is, the degree of anti-glare. In addition, each cell constituting the liquid crystal cell 402 may cause an event such as a diffraction grating with respect to the incident light, and reflected light 403 such as a rainbow may appear on the surface of the display structure 10. For convenience, the events appearing on the surface of the display structure as described above are referred to as “double reflection” and a “rainbow”, respectively.

FIG. 4B is also an enlarged view of the vicinity of the liquid crystal cell in the display having the display structure as shown in FIG. 3. A display 410 includes an upper polarization plate 411 and a liquid crystal cell 412. In the liquid crystal cell 412, a cell 412a, a cell 412b, and a cell 412c corresponding to RGB are disposed according to a predetermined rule. At this time, it is assumed that the upper polarization plate 411 is subjected to anti-glare (AG) processing to reduce diffuse reflection. In this configuration, the upper polarization plate 411 includes a filler 411a. The filler 411a suppresses the reflected light of the incident light 413, such as the rainbow that may be generated in the configuration of FIG. 4A. Further, since the filler 411a appears on a surface of the upper polarization plate 411, reflection of the incident light 414 is suppressed, and occurrence of the double reflection is suppressed. The degree of diffuse reflection is affected by the size of particles of the filler 411a. On the other hand, there is an aspect that the occurrence of the diffuse reflection caused by the filler 411a increases the degree to which the white blur occurs as described with reference to FIG. 2.

### Evaluation

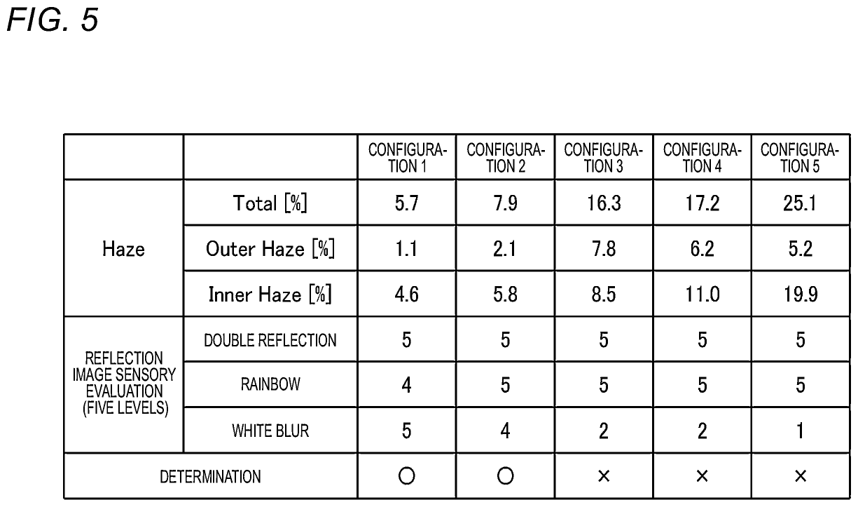

In view of the above, the inventor of the present disclosure specified that the occurrence of any of the double reflection, the rainbow, and the white blur can be suppressed by adjusting haze of the upper polarization plate in the structure of FIG. 4B. Hereinafter, an evaluation example based on the verification result will be described with reference to FIG. 5. A known method for measuring the haze is used, and a detailed description thereof is omitted here. The haze is calculated from a ratio of diffused transmitted light to total transmitted light. In this evaluation example, it is assumed that only the haze of the upper polarization plate is switched and other configurations are the same.

First, in the present embodiment, in order to suppress the occurrence of the double reflection and the rainbow, the anti-glare (AG) processing is applied to the upper polarization plate. In addition, by adjusting the haze of the upper polarization plate, the occurrence of the white blur is also suppressed.

In the evaluation example shown in FIG. 5, five Configuration Examples 1 to 5 are used, and the haze for each is changed. In the configuration, a sensory evaluation for the occurrence of the double reflection, the rainbow, and the white blur is performed by visual recognition of a person. In the sensory evaluation, the evaluation is performed in five stages (1 to 5), and “5” is the highest evaluation and “1” is the lowest evaluation. As shown in FIG. 4, since the anti-glare (AG) processing is performed, it is evaluated that the occurrence of the double reflection and the rainbow can be suppressed in any of configurations 1 to 5. On the other hand, in the haze of the configurations 3 to 5, the white blur occurs, and as a result, the evaluation value is low.

On the other hand, haze in the configurations 1 and 2 can suppress the occurrence of the white blur, and as a result, the evaluation value is high. In the configuration shown in FIG. 5, the occurrence of the white blur can be suppressed when the haze of the upper polarization plate is at least in the range of 5.7 to 7.9 [%], and the display structure with high display quality can be enabled. It has been confirmed that the occurrence of the white blur can be suppressed when the haze is in the range of 3.0 to 8.0 [%] in the study of the present inventor, and it is preferable to design the haze of the upper polarization plate of the electronic mirror in this range.

As described above, according to the present embodiment, an electronic mirror (for example, the electronic mirror 1) includes a first polarization plate (for example, the polarization plate 315), a liquid crystal layer (for example, the liquid crystal layer 316) disposed on a back surface side of the first polarization plate and controlling the optical rotation of the light by the applied voltage, a reflection-type polarization plate (for example, the reflection-type polarization plate 317) disposed on a back surface side of the liquid crystal layer and reflecting or transmitting light from the liquid crystal layer based on the polarization axis, a second polarization plate (for example, the upper polarization plate 331) disposed on a back surface side of the reflection-type polarization plate, a liquid crystal cell (for example, the liquid crystal cell 332) disposed on a back surface side of the second polarization plate, and a backlight (for example, the backlight 334) disposed on a back surface side of the liquid crystal cell, and haze of the second polarization plate is in a range of 3.0% to 8.0%.

Accordingly, it is possible to suppress occurrence of the white blur on the surface of the display structure of the electronic mirror. As a result, the visibility of a user can be improved.

Further, the anti-glare processing is applied to the second polarization plate.

Accordingly, it is possible to suppress occurrence of the double reflection and the rainbow on the surface of the display structure of the electronic mirror. As a result, the visibility of a user can be improved.

An air gap is formed between the reflection-type polarization plate and the second polarization plate.

Accordingly, it is possible to suppress a cost for constituting the electronic mirror, for example, a bonding cost, and a manufacturing process, and it is possible to manufacture the electronic mirror at a low cost.

### Embodiment 2

Embodiment 2 of the present disclosure will be described. The description of the configuration similar to that of Embodiment 1 will be omitted, and the description will focus on differences.

In the configuration example of the electronic mirror 1 shown in FIG. 3 of Embodiment 1, the configuration in which the air gap 320 is present between the front surface structure 310 and the display 330 is shown. The inventor of the present disclosure specifies that the air gap 320 affects the appearance of the double reflection. In the present embodiment, a configuration in which the air gap is replaced for the purpose of further suppressing the degree of appearance of the double reflection will be described.

### Layer Structure of Display Structure

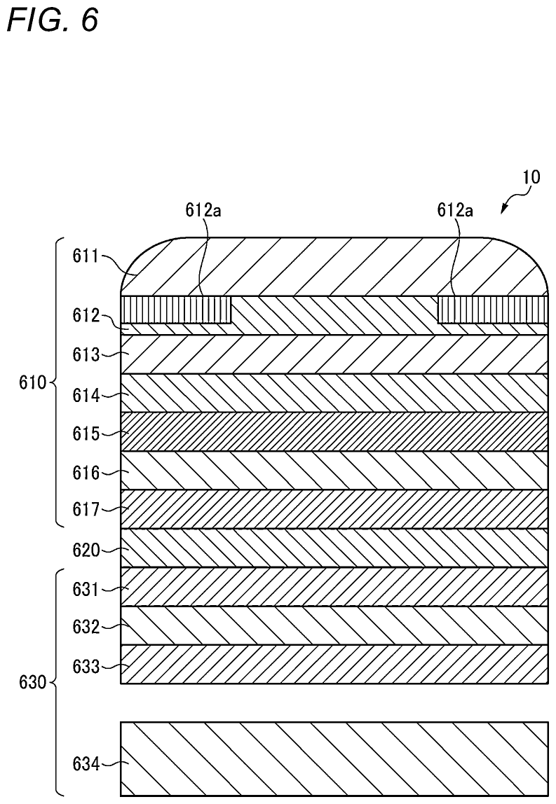

FIG. 6 is a schematic view for illustrating a layer structure of the display structure 10 according to the present embodiment. In FIG. 6, an upper side (a glass layer 611 side) corresponds to a front surface side of the electronic mirror 1, and a lower side (a backlight 634 side) corresponds to a back surface side of the electronic mirror 1.

Similarly to the configuration of Embodiment 1 shown in FIG. 3, the electronic mirror 1 according to the present embodiment includes a front surface structure 610 and a display 630, and each component is also similar to that in Embodiment 1. As a difference from FIG. 3, an adhesive layer 620 is provided between the front surface structure 610 and the display 630 instead of the air gap 320.

The adhesive layer 620 is configured to adhere the front surface structure 610 and the display 630 with a predetermined adhesive member. As the adhesive member here, for example, an acrylic adhesive, a silicon adhesive can be used. Further, the adhesive member may include a material having a diffusion function corresponding to the filler 411a in FIG. 4B. As the diffusion material, silica particles, that is, silicon-based particles may be used. In the case of the configuration without the diffusion component, the OCA or an optical clear resin (hereinafter, referred to as an “OCR”) may be used for the adhesive layer 620.

For the purpose of suppressing the occurrence of the double reflection and the rainbow as described in Embodiment 1, a combination of the component of the adhesive member constituting the adhesive layer 620 and the configuration of the upper polarization plate 631 may be designed as follows.

### Combination 1

Adhesive constituting adhesive layer 620: no diffusion component
Upper polarization plate 631: hard coat (HC)
Accordingly, it is possible to suppress the occurrence of the double reflection.

### Combination 2

Adhesive constituting adhesive layer 620: no diffusion component
Upper polarization plate 631: anti-glare (AG)
Accordingly, it is possible to suppress the occurrence of the double reflection and the rainbow.

### Technique 3

Adhesive constituting adhesive layer 620: having diffusion component
Upper polarization plate 631: hard coat (HC) or anti-glare (AG)
Accordingly, it is possible to suppress the occurrence of the double reflection and the rainbow.

As described above, according to the present embodiment, an electronic mirror (for example, the electronic mirror 1) includes a first polarization plate (for example, a polarization plate 615), a liquid crystal layer (for example, a liquid crystal layer 616) disposed on a back surface side of the first polarization plate and controlling the optical rotation of the light by the applied voltage, a reflection-type polarization plate (for example, a reflection-type polarization plate 617) disposed on a back surface side of the liquid crystal layer and reflecting or transmitting light from the liquid crystal layer based on the polarization axis, a second polarization plate (for example, the upper polarization plate 631) disposed on a back surface side of the reflection-type polarization plate, a liquid crystal cell (for example, a liquid crystal cell 632) disposed on a back surface side of the second polarization plate, and a backlight (for example, the backlight 634) disposed on a back surface side of the liquid crystal cell, and the reflection-type polarization plate and the second polarization plate are adhered by an adhesive member (for example, the adhesive layer 620).

Accordingly, it is possible to suppress occurrence of the double reflection and the rainbow on the display structure of the electronic mirror. As a result, the visibility of a user can be improved.

The adhesive member is an acrylic adhesive or a silicon adhesive. The adhesive member includes a diffusion material for diffusing light. Further, the diffusion material is silicon-based particles.

Accordingly, by adhering the reflection-type polarization plate and the upper polarization plate using any adhesive member, it is possible to suppress the occurrence of the double reflection and the rainbow on the display structure of the electronic mirror.

### Embodiment 3

Embodiment 3 of the present disclosure will be described. The description of the configuration similar to that of Embodiment 1 will be omitted, and the description will focus on differences.

In the configuration example of the electronic mirror 1 shown in FIG. 3 of Embodiment 1, the configuration in which the air gap 320 is present between the front surface structure 310 and the display 330 is shown. In Embodiment 2, the configuration in which the air gap affecting the appearance of the double reflection is eliminated has been described. On the other hand, in the present embodiment, a configuration in which the position of the air gap is changed for the purpose of further suppressing the degree of appearance of the double reflection will be described.

### Layer Structure of Display Structure

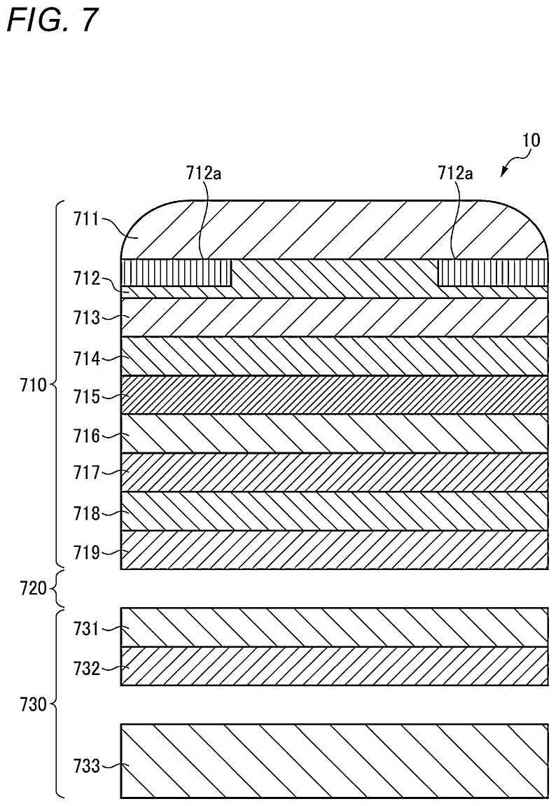

FIG. 7 is a schematic view for illustrating a layer structure of the display structure 10 according to the present embodiment. In FIG. 7, an upper side (a glass layer 711 side) corresponds to a front surface side of the electronic mirror 1, and a lower side (a backlight 733 side) corresponds to a back surface side of the electronic mirror 1.

Similarly to the configuration of Embodiment 1 shown in FIG. 3, the electronic mirror 1 according to the present embodiment includes a front surface structure 710 and a display 730, and each component is also similar to that in Embodiment 1. An air gap 720 is present between the front surface structure 710 and the display 730.

As a difference from Embodiment 1 shown in FIG. 3, the upper polarization plate provided in the display is moved to the front surface structure. Therefore, the front surface structure 710 includes a glass layer 711, an adhesive layer 712, a protective layer 713, an adhesive layer 714, a polarization plate 715, a liquid crystal layer 716, a reflection-type polarization plate 717, an adhesive layer 718, and an upper polarization plate 719 stacked in this order from the front surface side. Similarly to Embodiment 1, a reflectance control mechanism includes the polarization plate 715, the liquid crystal layer 716, and the reflection-type polarization plate 717. The adhesive layer 712, the adhesive layer 714, and the adhesive layer 718 are made of, for example, an OCA. The glass layer 711 and the adhesive layer 712 are adhered to each other, for example, at end portion regions 712a of the adhesive layer 712 by vapor deposition. The protective layer 713 is made of, for example, PET. The upper polarization plate 719 is made of, for example, a hard coat (HC).

The display 730 includes a liquid crystal cell 731, a lower polarization plate 732, and a backlight 733 stacked in this order from the front surface side.

With the above configuration, the reflected light caused by the upper polarization plate as shown in FIG. 4A is suppressed, and as a result, the occurrence of the double reflection can be suppressed.

As described above, according to the present embodiment, an electronic mirror (for example, the electronic mirror 1) includes a first polarization plate (for example, a polarization plate 715), a liquid crystal layer (for example, a liquid crystal layer 716) disposed on a back surface side of the first polarization plate and controlling the optical rotation of the light by the applied voltage, a reflection-type polarization plate (for example, a reflection-type polarization plate 717) disposed on a back surface side of the liquid crystal layer and reflecting or transmitting light from the liquid crystal layer based on the polarization axis, a second polarization plate (for example, an upper polarization plate 719) disposed on a back surface side of the reflection-type polarization plate, a liquid crystal cell (for example, the liquid crystal cell 731) disposed on a back surface side of the second polarization plate, and a backlight (for example, the backlight 733) disposed on a back surface side of the liquid crystal cell, and the reflection-type polarization plate and the second polarization plate are adhered by an adhesive member (for example, ab adhesive layer 718). Further, an air gap (for example, the air gap 720) is present between the second polarization plate and the liquid crystal cell.

Accordingly, it is possible to suppress occurrence of the double reflection and the rainbow on the display structure of the electronic mirror. As a result, the visibility of a user can be improved.

### Embodiment 4

Embodiment 4 of the present disclosure will be described. The description of the configuration similar to that of Embodiment 1 will be omitted, and the description will focus on differences.

As described with reference to FIG. 4 or the like, the double reflection occurs in the reflected light from the reflection-type polarization plate 317 of the front surface structure 310 and the reflected light from the upper polarization plate 331 of the display 330. Here, in the present embodiment, for the purpose of suppressing the appearance of the double reflection, these components are integrated, and a configuration corresponding to one component will be described.

### Layer Structure of Display Structure

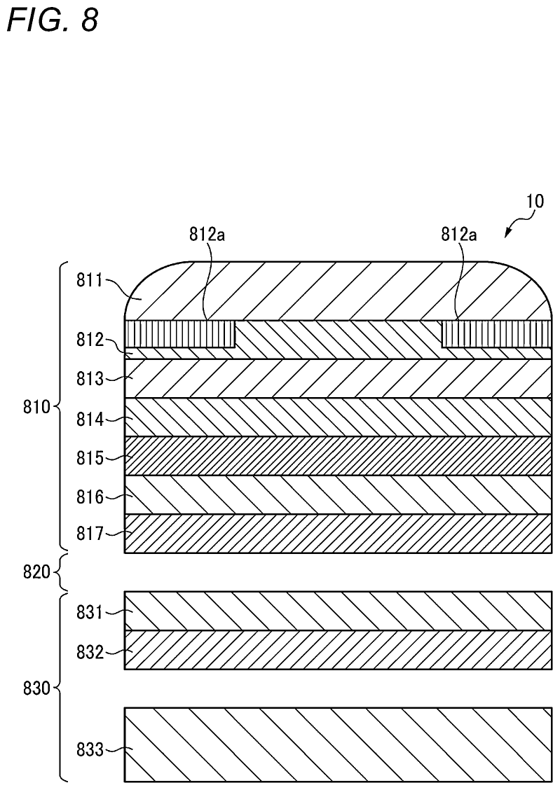

FIG. 8 is a schematic view for illustrating a layer structure of the display structure 10 according to the present embodiment. In FIG. 8, an upper side (a glass layer 811 side) corresponds to a front surface side of the electronic mirror 1, and a lower side (a backlight 833 side) corresponds to a back surface side of the electronic mirror 1.

Similarly to the configuration of Embodiment 1 shown in FIG. 3, the electronic mirror 1 according to the present embodiment includes a front surface structure 810 and a display 830, and each component is also similar to that in Embodiment 1. An air gap 820 is present between the front surface structure 810 and the display 830.

As a difference from Embodiment 1 shown in FIG. 3, the upper polarization plate provided in the display is removed. Therefore, the display 830 includes a liquid crystal cell 831, a lower polarization plate 832, and a backlight 833 stacked in this order from the front surface side. That is, functions of the reflection-type polarization plate 317 of the front surface structure 310 and the upper polarization plate 331 of the display 330 described in Embodiment 1 are implemented by a reflection-type polarization plate 817 of the front surface structure 810 in the present embodiment.

According to the present embodiment, the reflected light caused by the upper polarization plate as shown in FIG. 4A is suppressed, and as a result, the occurrence of the double reflection can be suppressed.

As described above, according to the present embodiment, an electronic mirror (for example, the electronic mirror 1) includes a first polarization plate (for example, a polarization plate 815), a liquid crystal layer (for example, a liquid crystal layer 816) disposed on a back surface side of the first polarization plate and controlling the optical rotation of the light by the applied voltage, a reflection-type polarization plate (for example, the reflection-type polarization plate 817) disposed on a back surface side of the liquid crystal layer and reflecting or transmitting light from the liquid crystal layer based on the polarization axis, a liquid crystal cell (for example, the liquid crystal cell 831) disposed on a back surface side of the reflection-type polarization plate, and a backlight (for example, the backlight 833) disposed on a back surface side of the liquid crystal cell.

Accordingly, it is possible to suppress occurrence of the double reflection on the display structure of the electronic mirror. As a result, the visibility of a user can be improved.

An air gap is present between the reflection-type polarization plate and the liquid crystal cell.

Accordingly, it is possible to suppress a cost for constituting the electronic mirror, for example, a bonding cost, and a manufacturing process, and it is possible to manufacture the electronic mirror at a low cost.

### Embodiment 5

Embodiment 5 of the present disclosure will be described. In the present embodiment, control for the electronic mirror having the above-described configuration will be described. A control method described in the present embodiment can be applied to any configuration of the electronic mirror shown in each of the above embodiments.

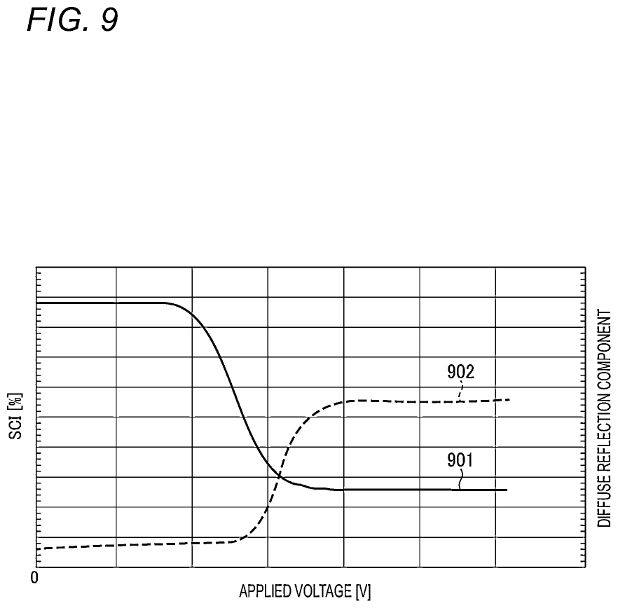

FIG. 9 is a graph for illustrating a relationship between an applied voltage to the liquid crystal layer and reflected light. In FIG. 9, a horizontal axis represents the applied voltage [V] to the liquid crystal layer, and a vertical axis represents specular component included (SCI: including specular reflected light) [%]. Here, an example in which the electronic mirror 1 having the configuration of Embodiment 1 shown in FIG. 3 is used is shown. Further, it is assumed that the upper polarization plate 331 is implemented by anti-glare (AG) in consideration of the double reflection and the rainbow.

A solid line 901 indicates a change in the SCI of the electronic mirror 1, that is, of the display structure 10 when the applied voltage is changed. A broken line 902 indicates a change in a diffuse reflection component by the upper polarization plate 331 when the applied voltage is changed. As indicated by the solid line 901, when the applied voltage is increased, since the reflectance of the reflection-type polarization plate 317 decreases, the SCI of the electronic mirror 1 tends to decrease. Further, as indicated by the broken line 902, when the applied voltage is increased, since transmittance is increased, the diffuse reflection component of the light transmitted through the front surface structure 310 by the upper polarization plate 331 tends to increase.

In an anti-glare function provided by the electronic mirror 1, as an example, the liquid crystal layer 316 may be controlled in a voltage range in which a value of the SCI of the display structure 10 is minimized. The voltage range in which the value of the SCI of the display structure 10 is minimized and the liquid crystal layer 316 is controlled is, for example, a voltage range in which the SCI of the display structure 10 is 13%. On the other hand, when the liquid crystal layer 316 is controlled in the voltage range in which the SCI is minimized, the diffuse reflection component by the upper polarization plate 331 increases as indicated by the broken line 902. The increase in the diffuse reflection component by the upper polarization plate 331 leads to an increase in size of the white blur in the electronic mirror 1. In the configuration of the electronic mirror 1 shown in FIG. 3, it has been determined through verification by the inventor of the present disclosure that when the liquid crystal layer 316 is controlled in a voltage range in which the value of the SCI is in a range of about 17 to 20%, the diffuse reflection component by the upper polarization plate 331 can be decreased to about 70% or less of the maximum value while the value of the SCI is reduced compared to the maximum value, and thus the white blur can be reduced. In the present embodiment, the white blur is reduced by adjusting the applied voltage based on the relationship between the applied voltage and the reflected light as shown in FIG. 9 and controlling the reflectance, that is, the transmittance of the reflectance control mechanism during the anti-glare.

A relationship between the applied voltage and the SCI may vary depending on a portion provided in the layer structure of the electronic mirror 1, for example, a configuration of the reflection-type polarization plate or the like. Therefore, the applied voltage is adjusted according to the configuration of the electronic mirror 1. The relationship between the applied voltage and the SCI may vary depending on a surrounding environment of the electronic mirror 1. Examples of the surrounding environment include an environmental temperature and environmental humidity of the electronic mirror 1. Here, the environmental temperature will be described as an example.

### Processing Flow

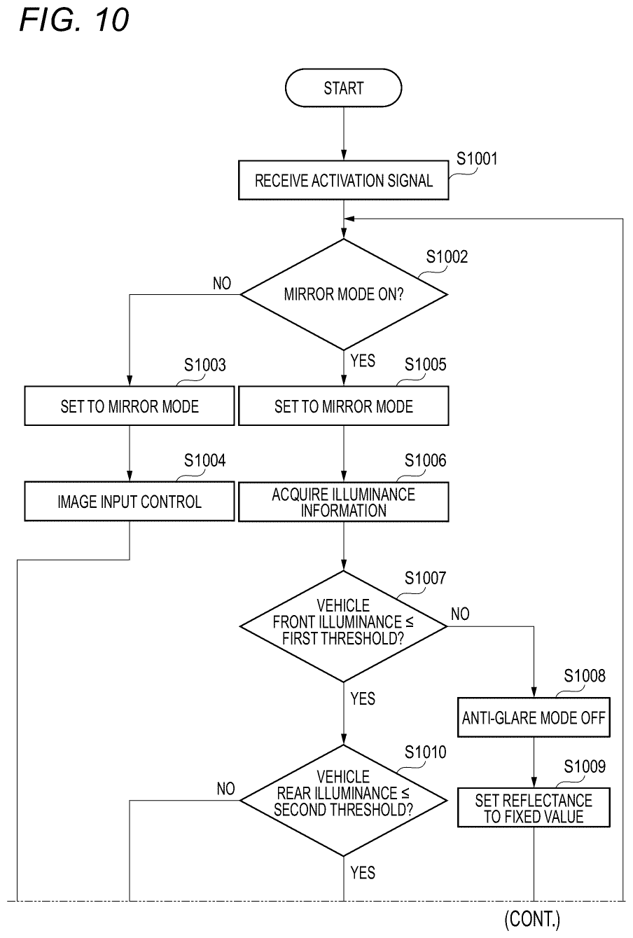

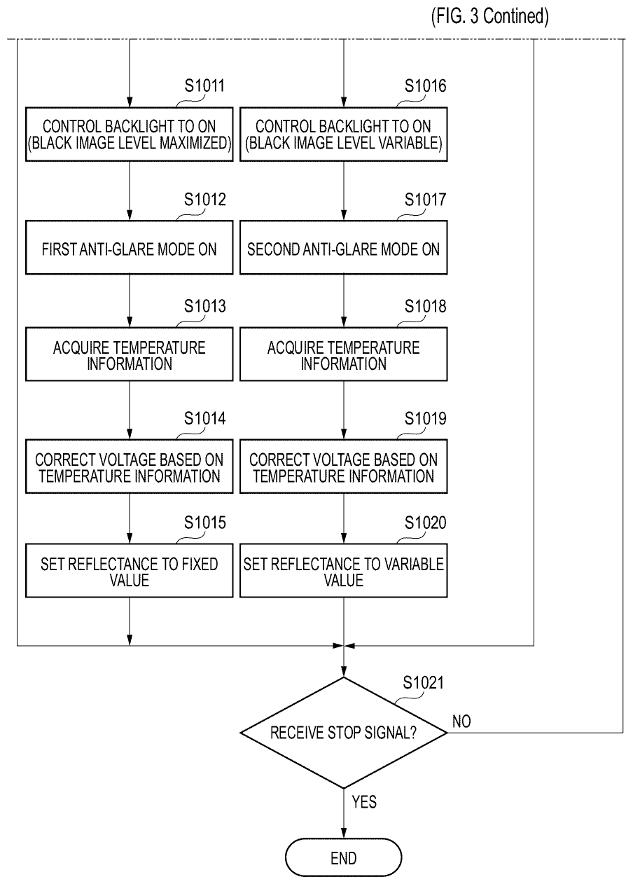

FIG. 10 is a flowchart of control processing of the electronic mirror 1 according to the present embodiment. This processing flow may be implemented by, for example, the control circuit 13 reading and executing a program or various data provided in the storage device 14. Here, in order to simplify the description, a main body of the processing will be collectively described as the control circuit 13.

The control circuit 13 receives an activation signal of the electronic mirror 1 from a vehicle (not shown) side (step S1001). The activation signal may be, for example, a notification signal indicating a state (for example, an ignition ON state) in which a vehicle (not shown) on which the electronic mirror 1 is mounted can travel, in addition to the start of power supply to the electronic mirror 1.

The control circuit 13 determines whether a setting to turn on the mirror mode is received (step S1002). The mirror mode may be freely set by the driver of the vehicle or may be automatically set on the vehicle side. The electronic mirror 1 according to the present embodiment is switchable between the mirror mode and the display mode. When the setting to turn on the mirror mode is received (step S1002: YES), the processing performed by the control circuit 13 proceeds to step S1005. On the other hand, when the setting to turn off the mirror mode, that is, to turn on the display mode is received (step S1002: NO), the processing performed by the control circuit 13 proceeds to step S1003.

The control circuit 13 sets the mode to the display mode (step S1003). Then, the processing performed by the control circuit 13 proceeds to step S1004.

The control circuit 13 performs predetermined video output control in the display mode (step S1004). The displayed image may be, for example, an image of the surroundings behind the vehicle captured by a camera (not shown) provided at a rear portion of the vehicle. Then, the processing performed by the control circuit 13 proceeds to step S1021.

The control circuit 13 sets the mode to the mirror mode (step S1005). Then, the processing performed by the control circuit 13 proceeds to step S1006.

The control circuit 13 acquires illuminance information indicating the illuminance of the light received by the electronic mirror 1 via the illuminance sensor 12 (step S1006). The illuminance information here includes illuminance of the light emitted toward the vehicle from a front side of the vehicle (that is, the back surface side of the electronic mirror 1) (hereinafter, referred to as “vehicle front illuminance”) and illuminance of the light emitted toward the vehicle from a back side of the vehicle (that is, the front surface side of the electronic mirror 1 where the display structure 10 is located) (hereinafter, referred to as “vehicle rear illuminance”).

The control circuit 13 determines whether the vehicle front illuminance is equal to or less than a first threshold based on the illuminance information acquired in step S1006 (step S1007). It is assumed that the first threshold is defined in advance and held in the storage device 14. When the vehicle front illuminance is equal to or less than the first threshold (step S1007: YES), the processing performed by the control circuit 13 proceeds to step S1010. On the other hand, when the vehicle front illuminance is larger than the first threshold (step S1007: NO), the processing performed by the control circuit 13 proceeds to step S1008.

The control circuit 13 sets the anti-glare mode of the electronic mirror to OFF (step S1008). The electronic mirror 1 according to the present embodiment can switch ON or OFF of the anti-glare mode when the mirror mode is ON.

The control circuit 13 controls the applied voltage to the liquid crystal layer 316 in the reflectance control mechanism to set the reflectance to a fixed value (step S1009). The fixed value of the reflectance used here may be defined in advance, and here, the reflectance of the reflection-type polarization plate 317 is controlled to be maximum. That is, the electronic mirror 1 is made to function similarly to a normal mirror. Then, the processing performed by the control circuit 13 proceeds to step S1021.

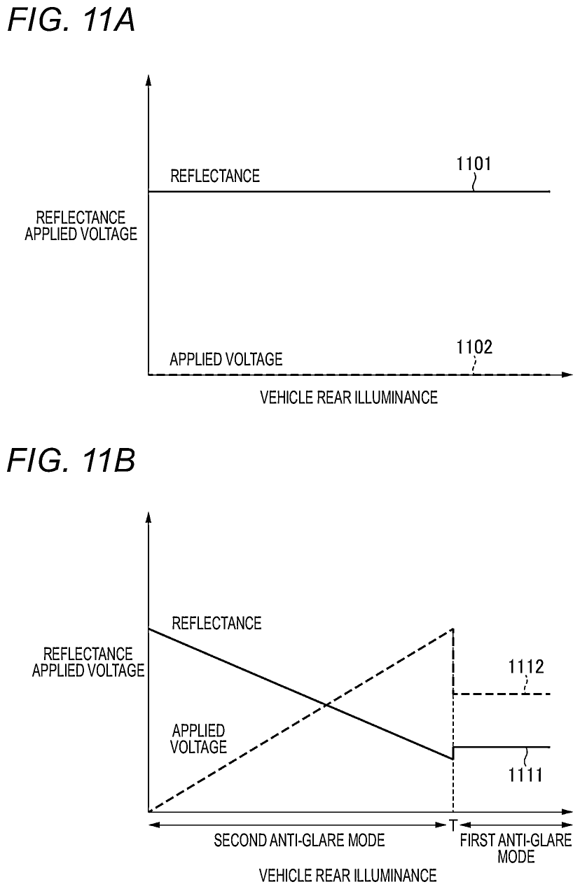

The control circuit 13 determines whether the vehicle rear illuminance is equal to or less than a second threshold based on the illuminance information acquired in step S1006 (step S1010). It is assumed that the second threshold is defined in advance and held in the storage device 14. The first threshold and the second threshold are not particularly limited, and the values may be defined taking into consideration the visibility when the driver checks the electronic mirror 1. In the present embodiment, the second threshold is defined in order to determine a case where the electronic mirror 1 receives light equivalent to high beams. A specific example will be described later with reference to FIGS. 11A and 11B. When the vehicle rear illuminance is equal to or less than the second threshold (step S1010: YES), the processing performed by the control circuit 13 proceeds to step S1016. On the other hand, when the vehicle rear illuminance is larger than the second threshold (step S1010: NO), the processing performed by the control circuit 13 proceeds to step S1011.

The control circuit 13 controls the backlight 334 to turn on the backlight 334 so as to maximize a black image level (step S1011). That is, the control circuit 13 controls light emission of the backlight 334 to maximize the expression of black. The black image level that can be indicated by the backlight 334 differs depending on, for example, a configuration of a dynamic range.

The control circuit 13 sets a first anti-glare mode to ON (step S1012). The first anti-glare mode here is a mode in which the anti-glare function is operated by controlling the reflectance of the reflectance control mechanism to be a fixed value. The first anti-glare mode operates, for example, in a state where the vehicle is receiving high-beam light from another vehicle behind, and prevents a reduction in the visibility of the electronic mirror 1 due to the high beam from the other vehicle behind.

The control circuit 13 acquires the temperature information indicating the peripheral temperature of the electronic mirror 1 via the temperature sensor 11 (step S1013).

The control circuit 13 corrects the applied voltage to the liquid crystal layer 316 based on the temperature information acquired in step S1013 (step S1014). The peripheral temperature of the electronic mirror 1 may change the relationship between the applied voltage and the SCI as shown in FIG. 9. According to the change in the correlation due to the change in the peripheral temperature, it is considered that the diffuse reflection component cannot be reduced to a desired degree by the applied voltage to the liquid crystal layer 316 before the correction. Therefore, in the present embodiment, by correcting the applied voltage based on the acquired temperature information, the diffuse reflection component is reduced to the desired degree, and the white blur is reduced. The correction method here is not particularly limited, and for example, the correction amount may be determined using a predefined table, or the value of the applied voltage may be determined using a predefined calculation formula.

The control circuit 13 applies the applied voltage determined in step S1014 to the liquid crystal layer 316, and sets the reflectance of the reflectance control mechanism to a fixed value (step S1015). The fixed value of the reflectance used here may be defined in advance, and is different from the fixed value set in step S1009. For convenience, the fixed value used in step S1009 is also referred to as a “first fixed value”, and the fixed value used in this step is also referred to as a “second fixed value”. Then, the processing performed by the control circuit 13 proceeds to step S1021.

The control circuit 13 controls the backlight 334 to turn on the backlight 334 such that the black image level is variable according to the vehicle rear illuminance (step S1016). That is, the control circuit 13 controls light emission of the backlight 334 based on the detected vehicle rear illuminance. The lighting control of the backlight 334 here may be performed based on, for example, a table defined in advance in association with the vehicle rear illuminance.

The control circuit 13 sets a second anti-glare mode to ON (step S1017). The second anti-glare mode here is a mode in which the anti-glare function is operated by controlling the reflectance of the reflectance control mechanism to be variable. The second anti-glare mode operates, for example, in a state other than the high beams, and switches the reflectance in the reflectance control mechanism according to the vehicle rear illuminance, thereby preventing a reduction in the visibility of the electronic mirror 1.

The control circuit 13 acquires temperature information indicating the peripheral temperature via the temperature sensor 11 (step S1018).

The control circuit 13 corrects the applied voltage to the liquid crystal layer 316 based on the temperature information acquired in step S1018 (step $1019). The correction here is not particularly limited, and may be similar to the process of step S1014 or may be performed using other information (for example, a table or a calculation formula).

The control circuit 13 applies the applied voltage determined in step S1019 to the liquid crystal layer 316 and adjusts the reflectance of the reflectance control mechanism (step S1020). The reflectance here varies according to the illuminance of the light received by the electronic mirror 1 (in particular, the vehicle rear illuminance). Then, the processing performed by the control circuit 13 proceeds to step S1021.

The control circuit 13 determines whether a stop signal for the electronic mirror 1 is received (step S1021). The stop signal may be, for example, a notification signal indicating that the operation of the vehicle (not shown) on which the electronic mirror 1 is mounted is stopped (for example, an ignition OFF state), in addition to the stop of the power supply to the electronic mirror 1. When the stop signal is received (step S1021: YES), the processing flow ends. On the other hand, when the stop signal is not received (step S1021: NO), the processing performed by the control circuit 13 returns to step S1002 and repeats the processing.

FIGS. 11A and 11B show graphs each showing a relationship between the illuminance and the reflectance and between the illuminance and the applied voltage according to the control of the processing flow shown in FIG. 10. In FIGS. 11A and 11B, a vertical axis represents the reflectance and the applied voltage, and a horizontal axis represents the vehicle rear illuminance detected by the illuminance sensor 12.

FIG. 11A is a graph corresponding to a case where the mirror mode and the anti-glare mode are OFF, that is, the operation of steps S1008 and S1009 in FIG. 10. A graph 1101 represents the reflectance, and a graph 1102 represents the applied voltage. In this mode, the applied voltage is controlled to be constant in the reflectance control mechanism regardless of the detected vehicle rear illuminance. In the present embodiment, the reflectance is a fixed value and is set to a maximum value.

FIG. 11B is a graph corresponding to a case where the mirror mode and the anti-glare mode are ON. As described above, the present embodiment, further uses the first anti-glare mode and the second anti-glare mode. The second threshold used in step S1010 of FIG. 10 corresponds to the threshold T shown in FIG. 11B. When the detected vehicle rear illuminance is equal to or less than the threshold T, the second anti-glare mode is operated, and when the detected vehicle rear illuminance is greater than the threshold T (for example, when the high beams are detected), the first anti-glare mode is operated.

A graph 1111 shows the reflectance, and a graph 1112 shows the applied voltage. In the second anti-glare mode, as the vehicle rear illuminance increases, the applied voltage is controlled to increase in the reflectance control mechanism. As a result, the reflectance is controlled to decrease as the vehicle rear illuminance increases. On the other hand, in the first anti-glare mode, the applied voltage is controlled to be constant in the reflectance control mechanism regardless of a change in the detected vehicle rear illuminance. Accordingly, the reflectance is the fixed value.

As described above, the inventor of the present disclosure specified that by controlling the applied voltage such that the SCI is in the range of 17 to 20% in the anti-glare mode, it is possible to reduce the diffuse reflection component caused by the structure of the electronic mirror 1 to the desired degree and reduce the white blur. Thus, in the graph of FIG. 11B, the applied voltage is controlled to be within the range of the above parameters.

FIGS. 11A and 11B show examples of the liquid crystal layer having a configuration in which the reflectance is reduced by increasing the applied voltage in the reflectance control mechanism, but the present disclosure is not limited thereto. Accordingly, even in a configuration in which the reflectance is increased by decreasing the applied voltage in the reflectance control mechanism, the same control can be performed. In the second anti-glare mode, the reflectance decreases in proportion to the increase in the vehicle rear illuminance. However, the decrease at this time is not limited to a negative proportion based on a constant decrease coefficient as shown in FIG. 11B. For example, a decrease in the reflectance may be represented by a curve.

As described above, according to the present embodiment, an electronic mirror (for example, the electronic mirror 1) that is capable of switching an anti-glare function includes: a display structure (for example, the display structure 10) in which the reflectance of light is controlled, an illuminance sensor (for example, the illuminance sensor 12) configured to acquire a first illuminance (for example, the vehicle rear illuminance) from a front surface side of the display structure and a second illuminance (for example, the vehicle front illuminance) from a back surface side of the display structure, and a control circuit (for example, the control circuit 13) configured to control the anti-glare function by adjusting an applied voltage to a liquid crystal layer (for example, the liquid crystal layer 316) provided in the display structure based on the first illuminance and the second illuminance, and the control circuit adjusts the applied voltage such that the reflectance of the display structure falls within a predetermined range during operation of the anti-glare function. Further, when the second illuminance is larger than the first threshold, the control circuit stops the anti-glare function and adjusts the applied voltage to the liquid crystal layer such that the reflectance of the display structure becomes the maximum value (for example, steps S1008 and S1009). When the second illuminance is equal to or less than the first threshold and the first illuminance is greater than the second threshold, the control circuit adjusts the applied voltage to the liquid crystal layer such that the reflectance of the display structure falls within the predetermined range (for example, step S1015). The display structure includes a reflection-type polarization plate (for example, the reflection-type polarization plate 317) located on a back surface side of the liquid crystal layer and a polarization plate (for example, the upper polarization plate 331) located on a back surface side of the reflection-type polarization plate, and the predetermined range is defined such that a diffuse reflection component of light incident from the front surface side by the polarization plate is 70% or less of a maximum value. Further, the predetermined range is defined such that specular component include (SCI) of the display structure is in the range of 17 to 20%. When the second illuminance is equal to or less than the first threshold and the first illuminance is equal to or less than the second threshold, the control circuit adjusts the applied voltage such that the reflectance of the display structure decreases as the second illuminance increases (for example, step S1020).

Accordingly, it is possible to suppress occurrence of the white blur on the display structure of the electronic mirror. As a result, the visibility of the user can be improved.

Further, a temperature sensor (for example, 11) that acquires a peripheral temperature of the electronic mirror is provided, and the control circuit corrects the applied voltage to the liquid crystal layer based on the peripheral temperature.

Accordingly, it is possible to provide the anti-glare function that suppresses the occurrence of the white blur in response to a change in the peripheral temperature.

When the second illuminance is equal to or less than the first threshold and the first illuminance is greater than the second threshold, the control circuit adjusts the black image level of the backlight provided in the electronic mirror to a maximum (for example, step S1011).

Accordingly, it is possible to make the reflection on the upper polarization plate less noticeable when receiving light having a certain or higher illuminance, such as high beams. As a result, the visibility of the user can be improved.

When the second illuminance is equal to or less than the first threshold and the first illuminance is equal to or less than the second threshold, the control circuit adjusts the black image level of the backlight provided in the electronic mirror according to the first illuminance.

Accordingly, the visibility of the user can be improved by adjusting the black image level according to the detected illuminance.

### Other Embodiments

Although various embodiments have been described above with reference to the drawings, it is needless to say that the present disclosure is not limited to such examples. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, the components in the various embodiments described above may be combined freely in a range without deviating from the spirit of the disclosure.

In addition, in the present specification, expressions “first” and “second” are merely used to distinguish from other elements, and should not be interpreted as being limited to specific components. These expressions may be interpreted appropriately depending on the configurations and relationships to which the present disclosure is applied.

### Note

The following techniques are disclosed based on the above description of the embodiments.

### Technique 1

An electronic mirror includes: a first polarization plate; a liquid crystal layer disposed on a back surface side of the first polarization plate and configured to control optical rotation of light by an applied voltage; a reflection-type polarization plate disposed on a back surface side of the liquid crystal layer and configured to reflect or transmit light from the liquid crystal layer based on a polarization axis; a second polarization plate disposed on a back surface side of the reflection-type polarization plate; a liquid crystal cell disposed on a back surface side of the second polarization plate; and a backlight disposed on a back surface side of the liquid crystal cell, and haze of the second polarization plate is configured to be within a range of 3.0% to 8.0%.

With this configuration, it is possible to suppress occurrence of a white blur on a surface of a display structure of the electronic mirror. As a result, the visibility of a user can be improved.

### Technique 2

In the electronic mirror according to Technique 1, anti-glare processing is applied to the second polarization plate.

With this configuration, it is possible to suppress occurrence of double reflection and a rainbow on the surface of the display structure of the electronic mirror. As a result, the visibility of the user can be improved.

### Technique 3

In the electronic mirror according to Technique 1 or 2, an air gap is formed between the reflection-type polarization plate and the second polarization plate.

With this configuration, it is possible to suppress a cost for constituting the electronic mirror, for example, a bonding cost, and a manufacturing process, and it is possible to manufacture the electronic mirror at a low cost.

### Technique 4

An electronic mirror includes: a first polarization plate; a liquid crystal layer disposed on a back surface side of the first polarization plate and configured to control optical rotation of light by an applied voltage; a reflection-type polarization plate disposed on a back surface side of the liquid crystal layer and configured to reflect or transmit light from the liquid crystal layer based on a polarization axis; a second polarization plate disposed on a back surface side of the reflection-type polarization plate; a liquid crystal cell disposed on a back surface side of the second polarization plate; and a backlight disposed on a back surface side of the liquid crystal cell, and the reflection-type polarization plate and the second polarization plate are adhered by an adhesive member.

With this configuration, it is possible to suppress occurrence of double reflection and a rainbow on a display structure of the electronic mirror. As a result, the visibility of a user can be improved.

### Technique 5

In the electronic mirror according to Technique 4, the adhesive member is an acrylic adhesive or a silicon adhesive.

According to this configuration, by adhering the reflection-type polarization plate and the upper polarization plate using any adhesive member, it is possible to suppress the occurrence of the double reflection and the rainbow on the display structure of the electronic mirror.

### Technique 6

In the electronic mirror according to Technique 4 or 5, the adhesive member includes a diffusion material for diffusing light.

According to this configuration, by adhering the reflection-type polarization plate and the upper polarization plate using any adhesive member, it is possible to suppress the occurrence of the double reflection and the rainbow on the display structure of the electronic mirror.

### Technique 7

In the electronic mirror according to Technique 6, the diffusion material is silicon-based particles.

According to this configuration, by adhering the reflection-type polarization plate and the upper polarization plate using any adhesive member, it is possible to suppress the occurrence of the double reflection and the rainbow on the display structure of the electronic mirror.

### Technique 8

In the electronic mirror according to any one of Techniques 4 to 7, an air gap is present between the second polarization plate and the liquid crystal cell.

According to this configuration, by adhering the reflection-type polarization plate and the upper polarization plate using any adhesive member, it is possible to suppress the occurrence of the double reflection and the rainbow on the display structure of the electronic mirror. As a result, the visibility of the user can be improved.

### Technique 9

An electronic mirror includes: a first polarization plate; a liquid crystal layer disposed on a back surface side of the first polarization plate and configured to control optical rotation of light by an applied voltage; a reflection-type polarization plate disposed on a back surface side of the liquid crystal layer and configured to reflect or transmit light from the liquid crystal layer based on a polarization axis; a liquid crystal cell disposed on a back surface side of the reflection-type polarization plate; and a backlight disposed on a back surface side of the liquid crystal cell.

With this configuration, it is possible to suppress the occurrence of double reflection on a display structure of the electronic mirror. As a result, the visibility of a user can be improved.

### Technique 10

In the electronic mirror according to Technique 9, an air gap is present between the reflection-type polarization plate and the liquid crystal cell.

With this configuration, it is possible to suppress a cost for constituting the electronic mirror, for example, a bonding cost, and a manufacturing process, and it is possible to manufacture the electronic mirror at a low cost.

### Technique 11

An electronic mirror that is capable of switching an anti-glare function includes: a display structure in which the reflectance of light is controlled; an illuminance sensor configured to acquire a first illuminance from a front surface side of the display structure and a second illuminance from a back surface side of the display structure; and a control circuit configured to control the anti-glare function by adjusting an applied voltage to a liquid crystal layer provided in the display structure based on the first illuminance and the second illuminance, and the control circuit adjusts the applied voltage such that the reflectance of the display structure falls within a predetermined range during operation of the anti-glare function.

With this configuration, it is possible to suppress occurrence of a white blur on the display structure of the electronic mirror. As a result, the visibility of a user can be improved.

### Technique 12

In the electronic mirror according to Technique 11, when the second illuminance is larger than a first threshold, the control circuit stops the anti-glare function and adjusts the applied voltage to the liquid crystal layer such that the reflectance of the display structure becomes a maximum value.

With this configuration, it is possible to suppress the occurrence of the white blur on the display structure of the electronic mirror. As a result, the visibility of the user can be improved.

### Technique 13

In the electronic mirror according to Technique 11 or 12, when the second illuminance is equal to or less than a first threshold and the first illuminance is greater than a second threshold, the control circuit adjusts the applied voltage to the liquid crystal layer such that the reflectance of the display structure falls within the predetermined range.

With this configuration, it is possible to suppress the occurrence of the white blur on the display structure of the electronic mirror. As a result, the visibility of the user can be improved.

### Technique 14

In the electronic mirror according to Technique 13, the display structure includes a reflection-type polarization plate located on a back surface side of the liquid crystal layer and a polarization plate located on a back surface side of the reflection-type polarization plate, and the predetermined range is defined such that a diffuse reflection component of light incident from the front surface side by the polarization plate is 70% or less of a maximum value.

With this configuration, it is possible to suppress the occurrence of the white blur on the display structure of the electronic mirror. As a result, the visibility of the user can be improved.

### Technique 15

In the electronic mirror according to Technique 13, the predetermined range is defined such that specular component include (SCI) of the display structure is in a range of 17 to 20%.

With this configuration, it is possible to suppress the occurrence of the white blur on the display structure of the electronic mirror. As a result, the visibility of the user can be improved.

### Technique 16

In the electronic mirror according to any one of Techniques 11 to 15, when the second illuminance is equal to or less than a first threshold and the first illuminance is equal to or less than a second threshold, the control circuit adjusts the applied voltage such that the reflectance of the display structure decreases as the second illuminance increases.

With this configuration, it is possible to suppress the occurrence of the white blur on the display structure of the electronic mirror. As a result, the visibility of the user can be improved.

### Technique 17

The electronic mirror according to any one of Techniques 11 to 16 further includes: a temperature sensor configured to acquire a peripheral temperature of the electronic mirror, in which the control circuit corrects the applied voltage to the liquid crystal layer based on the peripheral temperature.

With this configuration, it is possible to provide the anti-glare function that suppresses the occurrence of the white blur in response to a change in the peripheral temperature.

### Technique 18

In the electronic mirror according to any one of Techniques 11 to 17, when the second illuminance is equal to or less than a first threshold and the first illuminance is greater than a second threshold, the control circuit adjusts a black image level of a backlight provided in the electronic mirror to a maximum.

With this configuration, it is possible to make the reflection on the upper polarization plate less noticeable when receiving light having a certain or higher illuminance, such as high beams. As a result, the visibility of the user can be improved.

### Technique 19

In the electronic mirror according to any one of Techniques 11 to 18, when the second illuminance is equal to or less than a first threshold and the first illuminance is equal to or less than a second threshold, the control circuit adjusts a black image level of a backlight provided in the electronic mirror according to the first illuminance.

With this configuration, the visibility of the user can be improved by adjusting the black image level according to the detected illuminance.

### Technique 20

A method for controlling an electronic mirror that is capable of switching an anti-glare function includes: an acquisition step of acquiring a first illuminance from a front surface side of a display structure of the electronic mirror and a second illuminance from a back surface side of the display structure; and a control step of controlling the anti-glare function by adjusting an applied voltage to a liquid crystal layer provided in the display structure of the electronic mirror and controlling the reflectance of light of the display structure based on the first illuminance and the second illuminance, in which the applied voltage is adjusted such that the reflectance of the display structure falls within a predetermined range during operation of the anti-glare function.

With this configuration, it is possible to suppress occurrence of a white blur on the display structure of the electronic mirror. As a result, the visibility of a user can be improved.

Although various embodiments have been described above, it is needless to say that the present disclosure is not limited to these embodiments. It is apparent that those skilled in the art can conceive of various modifications or corrections within the scope described in the claims, and it is understood that such modifications or corrections naturally fall within the technical scope of the present disclosure. In addition, the components in the above embodiment may be freely combined in a range without deviating from the spirit of the disclosure.

### INDUSTRIAL APPLICABILITY

The present disclosure is useful as an electronic mirror and a method for controlling the electronic mirror.

What is claimed is:

1. An electronic mirror comprising:
a first polarization plate;
a liquid crystal layer disposed on a back surface side of the first polarization plate and configured to control optical rotation of light by an applied voltage;
a reflection-type polarization plate disposed on a back surface side of the liquid crystal layer and configured to reflect or transmit light from the liquid crystal layer based on a polarization axis;
a second polarization plate disposed on a back surface side of the reflection-type polarization plate;
a liquid crystal cell disposed on a back surface side of the second polarization plate; and
a backlight disposed on a back surface side of the liquid crystal cell, wherein
haze of the second polarization plate is within a range of 3.0% to 8.0%.

2. The electronic mirror according to claim 1, wherein
anti-glare processing is applied to the second polarization plate.

3. The electronic mirror according to claim 1, wherein
an air gap is formed between the reflection-type polarization plate and the second polarization plate.

4. The electronic mirror according to claim 1, wherein
the haze of the second polarization plate is within a range of 5.7% to 7.9%.

5. The electronic mirror according to claim 1, wherein
the haze of the second polarization plate is calculated from a ratio of diffused transmitted light to total transmitted light.

6. The electronic mirror according to claim 4, wherein
the haze of the second polarization plate is calculated from a ratio of diffused transmitted light to total transmitted light.

7. The electronic mirror according to claim 1, wherein
the second polarization plate includes a filler.

8. The electronic mirror according to claim 1, wherein
the second polarization plate is subjected to surface treatment of hard coat.

9. The electronic mirror according to claim 1, wherein
the second polarization plate is subjected to surface treatment of anti-reflection.

10. The electronic mirror according to claim 1, wherein
the liquid crystal layer is made of a twisted nematic liquid crystal.

11. The electronic mirror according to claim 1, wherein
the electronic mirror is switchable between a mode in which the electronic mirror functions as a normal mirror and a mode in which any image is displayed on a liquid crystal display.
